(19) United States
(12) Patent Application Publication
(10) Pub. No.: US 2016/0096402 A1
(43) Pub. Date: Apr. 7, 2016

(54) TIRE PRESSURE MONITORING SYSTEM

(71) Applicant: Tortured Genius Enterprises, Phoenix, AZ (US)

(72) Inventors: Joseph Carlin, Gilbert, AZ (US); Jose Martinez, Maricopa, AZ (US); Kevin Stockard, Phoenix, AZ (US)

(21) Appl. No.: 14/872,867

(22) Filed: Oct. 1, 2015

Related U.S. Application Data
(60) Provisional application No. 62/058,395, filed on Oct. 1, 2014.

(51) Int. Cl. B60C 23/02; H04W 4/14

(52) U.S. Cl. CPC B60C 23/02; H04W 4/14

(57) ABSTRACT

A vehicle tracking and identification system is provided. The system identifies a vehicle, determines its location, and retrieves information regarding the vehicle and/or its owner via transmissions received from a tire pressure monitoring system (“TPMS”). Law enforcement agencies may utilize the system and/or its data to conduct surveillance and commercial enterprises may utilize the system and/or its data to conduct marketing, among other users and uses.

### CLAIM OF PRIORITY

This application claims priority to U.S. Provisional Patent Application Ser. No. 62/058,395, filed Oct. 1, 2014, entitled “TIRE PRESSURE MONITORING SYSTEM”, which is hereby incorporated by reference.

### FIELD

The present invention relates to a vehicle tracking and identification system, and more particularly, a vehicle tracking and identification system capable of identifying vehicles by transmissions from their tire pressure monitoring systems.

### BACKGROUND

Vehicle tires often include a Tire Pressure Monitoring System (“TPMS”). A sensor located at each tire reports tire pressure data to a receiving unit in the vehicle, whereby the vehicle may alert the driver to tire pressure anomalies. The Tread Act of 2002 is a Congressional mandate that states that passenger vehicles and light trucks are required to be equipped with TPMS hardware.

Vehicle tracking and identification systems often include cameras to photograph license plates, or discretely attachable radio transmitters. However, cameras fail to work effectively during low light conditions, or depending on the direction of the vehicle travel. Discretely attachable radio transmitters are costly and must be attached to each vehicle desired to be identified or tracked.

### SUMMARY

A tire pressure monitoring system collection system is provided. The tire pressure monitoring system collection system may include a plurality of collectors whereby TPMS data is received, a controller whereby an identity of a source of the TPMS data is determined, and a user interface whereby the identity of the source is displayed to a user.

A collector is provided. The collector may include a radio in RF communication with a remote, mobile TPMS source, and a network interface in logical communication with the radio. TPMS data may be received by the radio from the TPMS source. The network interface may provide at least a portion of the TPMS data to a network.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 illustrates a block diagram illustrating a TPMS monitoring environment having multiple TPMS sources and a TPMS collection system according to various embodiments;

FIG. 2 illustrates various aspects of a collector unit of a TPMS collection system according to various embodiments;

FIG. 3 illustrates various aspects of a controller unit of a TPMS collection system according to various embodiments;

FIG. 4 illustrates various example functions of various aspects of a TPMS collection system interacting with a TPMS source according to various embodiments;

FIG. 5A illustrates an example user interface of an interface device of a TPMS collection system according to various embodiments;

FIG. 5B illustrates an example user interface of an interface device of a TPMS collection system including a SMS message according to various embodiments;

FIG. 6 illustrates an example application environment for a TPMS collection system according to various embodiments;

FIG. 7 illustrates an example method of using a TPMS collection system according to various embodiments;

FIG. 8 illustrates an example method of using a TPMS collection system to retrieve stored data according to various embodiments; and

FIG. 9 illustrates an example method of using a TPMS collection system to identify a passing vehicle according to various embodiments.

### DETAILED DESCRIPTION

The detailed description of exemplary embodiments herein refers to the accompanying drawings, which show exemplary embodiments by way of illustration and their best mode. While these exemplary embodiments are described in sufficient detail to enable those skilled in the art to practice the inventions, it should be understood that other embodiments may be realized and that logical, chemical and mechanical changes may be made without departing from the spirit and scope of the disclosure. Thus, the detailed description herein is presented for purposes of illustration only and not of limitation. For example, the steps recited in any of the method or process descriptions may be executed in any order and are not necessarily limited to the order presented.

Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

As used herein, phrases such as “make contact with,” “coupled to,” “touch,” “interface with” and “engage” may be used interchangeably. As used herein, “logical communication” or “logical connection” may refer to any method by which information may be conveyed. Logical communication may facilitate the transmission of signals, whether analog or digital, between two or more components. Thus, “logical communication” may refer to any electrical, electromagnetic, radiofrequency and/or optical method whereby information may be conveyed.

A collector is provided. The collector is configured to communicate with a tire pressure monitoring system (“TPMS”) source via RF signals. The TPMS source and the collector are not connected to the same vehicle. For example, the collector can be located in a fixed location (e.g., a light pole) at an intersection. In another example, the collector is located on a police vehicle near the target vehicle. The TPMS source is located in one or more tire of the target vehicle. The collector receives signals from the TPMS source. These TPMS signals include an unique identifier. The TPMS signals received may also contain information such as tire pressure, tire health, rate of revolution, tire temperature, etc. This information can be collected and used by itself in a variety of ways. For example, for traffic studies (speed, congestion, etc.), asphalt studies, police investigations and the like. Moreover, this information can be collected, cross-referenced with third-party databases to determine the owner, vehicle make and model, etc. As such, queries can be made to track a vehicle, locate stolen vehicles, capture criminals, assist Amber alerts, improve vehicle safety, and promote various commercial interests, such as targeted advertising based on the TPMS data received from the TPMS sources.

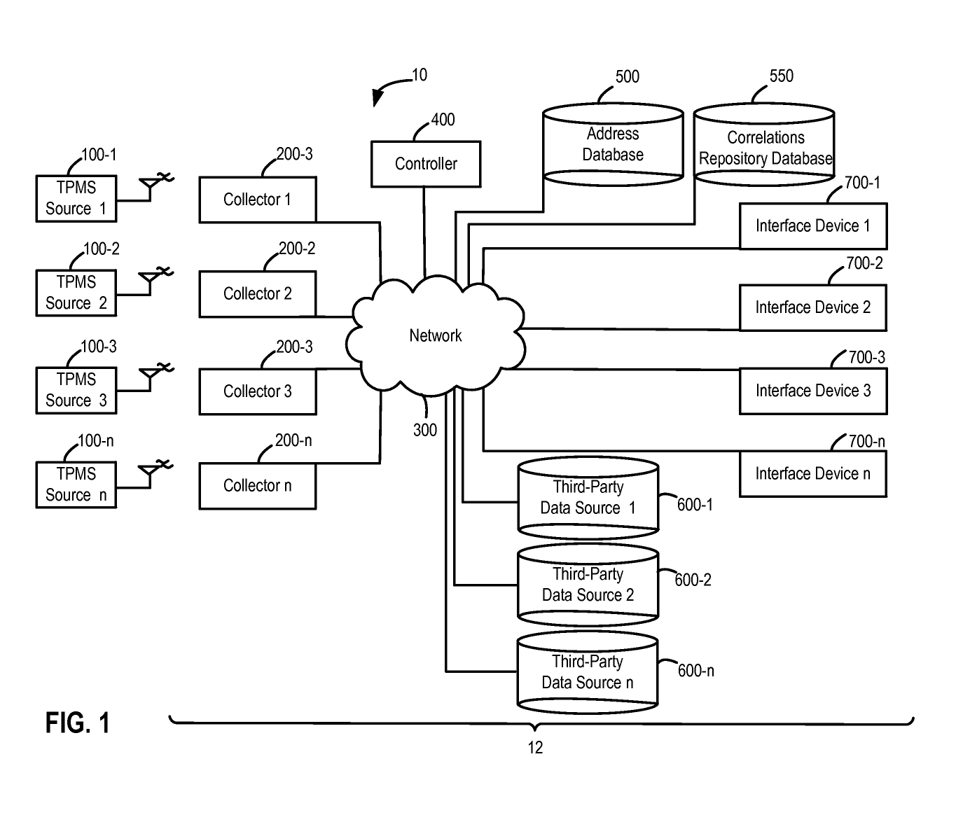

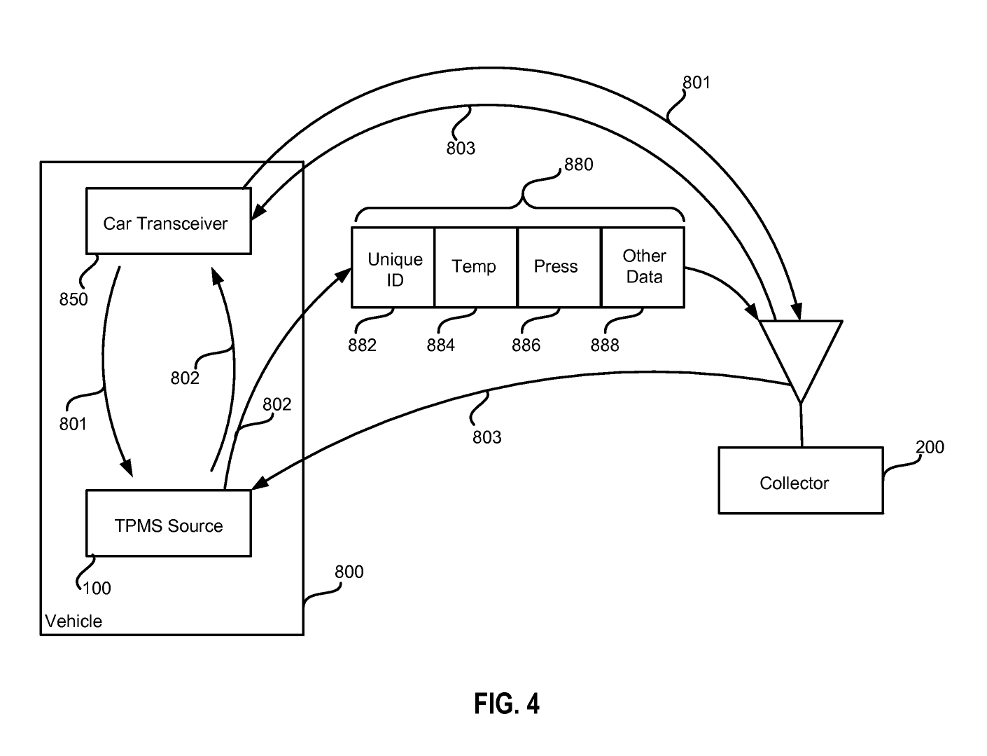

With reference to FIG. 1, a tire pressure monitoring system (“TPMS”) monitoring environment 10 may include one or more TPMS source 100 and a TPMS collection system 12. For example, a TPMS monitoring environment 10 may comprise a first TPMS source 100-1, a second TPMS source 100-2, a third TPMS source 100-3, and any number of TPMS sources 100, such as a N^{th} TPMS source 100-n. Each TPMS source 100 may be associated with a vehicle (800; FIG. 4). Furthermore, more than one TPMS source 100 may be associated with a single vehicle. For example, a TPMS source 100 may be located in each tire of a vehicle.

A TPMS monitoring environment 10 may also include a TPMS collection system 12. A TPMS collection system 12 may monitor transmissions from one or more TPMS source 100 and may determine the identity, location, time/distance in service, and/or other characteristics of the one or more TPMS source 100. More generally, a TPMS source may be located on a vehicle wheel and/or tire, and emits an unique identifier and other data that can be used in contexts other than onboard tire pressure safety, and can be used off-board the vehicle.

As will be discussed further herein, a TPMS monitoring environment 10 may comprise a variety of scenarios. For instance, a TPMS monitoring environment 10 may comprise various operations contexts, such as a law enforcement surveillance operation, or may comprise a traffic congestion monitoring scenario, a tire life assessment situation, or any event, location, geography, or purpose in which it is desirable to monitor transmissions from one or more TPMS source 100 and determine the identity, location, time/distance in service, and/or other characteristics of the one or more TPMS source 100. A TPMS monitoring environment 10 may comprise whether a TPMS source 100 has entered a location of interest, has left a location of interest, the speed at which a TPMS source 100 is moving, historical data/behavior of the TPMS source 100, such as most frequently visited locations, routes, predicted future behavior of the TPMS source 100, and/or any other information regarding the actions, location, past behavior, present behavior, or predicted behavior of the TPMS source 100. Moreover, a TPMS monitoring environment 10 may include many TPMS sources 100, so that such factors may be considered individually or jointly; for example, the TPMS monitoring environment 10 may include aggregate behavior such as predicted road congestion or areas of concentrated vehicle-related criminal activity, and the like.

With continuing reference to FIG. 1 and with additional reference to FIG. 4, a TPMS collection system 12 may comprise one or more collector 200, a network 300, a controller 400, an address database 500, a collections repository database 550, one or more third-party data source 600, and one or more interface device 700. A collector 200 may be located offboard the vehicle associated with a TPMS source 100, but may receive transmissions from the TPMS source 100. A collector 200 may receive TPMS source radio transmissions 802 comprising TPMS data 880 transmitted by a TPMS source 100. The collector 200 may process the TPMS data 880 and may be operatively coupled to (e.g., in “logical communication” with) a controller 400 via a network 300. The collector 200 may communicate with the network 300 in various ways. The TPMS data 880 may be stored in the collections repository database 550. The controller 400 may accept input from the collector 200 and one or more of an address database 500, collections repository database 550, third-party data source 600, and interface device 700, and may provide a desired output to one or more user via one or more interface device 700. In this manner, the TPMS data 880 may be processed by the controller 400 in response to one or more third-party data source 600, the address database 500, and potentially, further instructions provided from one or more interface device 700. A user output is provided at one or more interface device 700 by the controller 400 in response to the processing.

A TPMS collection system 12 may comprise multiple collectors 200. For example, a TPMS collection system 12 may comprise a first collector 200-1, a second collector 200-2, a third collector 200-3, and any number ‘n’ of collectors 200, such as a N^{th} collector 200-n. In various embodiments, a TPMS collection system 12 comprises many collectors 200. For example, a collector 200 may be positioned at an intersection of a roadway and may monitor transmissions from one or more TPMS source 100 proximate to the collector 200. Moreover, a collector 200 may be positioned along a stretch of roadway, or at an underpass, or at an overpass, or at a light pole, or at any desired location. As such, a TPMS collection system 12 may comprise dozens of collectors 200, or hundreds of collectors 200, or thousands of collectors 200, or any number of collectors 200. Moreover, a collector 200 may be positioned on a temporarily installable platform, such as a magnetic mount for attachment to a building, mailbox, light pole, street controls, stop lights, or temporarily placeable platform, or on a mobile platform, such as an aircraft, or a helicopter, or police car, or trailer, or golf cart, or personal transporter, or an unmanned vehicle, such as an unmanned aerial vehicle, or an unmanned underwater vehicle, or an unmanned surface vehicle, or any mobile platform, such as a law enforcement vehicle. Furthermore, a collector 200 may be positioned on an autonomous vehicle and one or more control systems of the vehicle may interface with TPMS collection system 12 so that the vehicle may be autonomously moved in response to one or more collector 200 and/or controller 400, such as to follow a TPMS source 200.

A collector 200 may communicate with the network 300 (discussed herein) in various ways. For example, a collector 200 may communicate with the network 300 by Bluetooth Low Energy (“BLE”) communication, by cellular communication, by Wi-Fi communication, by Near-Field Communication (“NFC”), or by any IEEE 802 standard communications technology, or by any technology. In further embodiments, the collector 200 communicates with the network 300 by an optical communication technology, for example, by fiber optic communication, or through-the-air optical communication, such as by a laser or by infrared light. In still further embodiments, a collector 200 communicates with the network 300 by a variety of technologies, for example, having the ability to communicate with the network by a proprietary radio channel, or by a cellular technology, or by a combination of technologies depending on what communications infrastructure is present in a given area. In this manner, the collector 200 may adapt to interoperate with the communications technology available, such as permitting Wi-Fi, cellular, Bluetooth, and/or proprietary communications mechanisms and selecting one or more that is implemented in an area based on automated detection.

A TPMS collection system 12 may comprise a network 300. A network 300 may be any suitable communications network including the Internet, a radio network, for example, a supervisory control and data acquisition (“SCADA”) network, a trunked radio network, a radio repeater system, or any communications mechanism or combination of communications mechanisms. In this regard, network 300 may be configured to receive data, such as TPMS data 880, from TPMS collection system 12 components and distribute that data to other components of the TPMS collection system 12 and/or any entity or other network or component desired to utilize the data. Moreover, network 300 may be configured to facilitate the transmission and receipt of data among components of the TPMS collection system 12 in substantially real time. In this regard, network 300 may be capable of and/or configured to facilitate real-time location tracking of TPMS sources 100. In various embodiments, network 300 may include at least a portion of one or more collector 200, controller 400, address database 500, third-party data source 600, and/or interface device 700. The network 300 may communicate by any of the technologies mentioned above with respect to the collector 200. Moreover, the network 300 may communicate by any combination of technologies, or by a technology different from that mentioned with respect to the collector 200. For example, the network 300 may comprise a wired network with wireless endpoints whereby the collectors 200 communicated with the wired network.

A TPMS collection system 12 may comprise a controller 400. A controller 400 may comprise a processor and a tangible, non-transitory memory. The processor may receive and process the TPMS data 880, request other data, or transmit TPMS data 880 or other data in response to the receiving. The processor may receive data, for example, in response to a polling request sent by the controller 400 to other system components, or the processor may receive data, for example, in response to a transmission initiated by other system components. Similarly, the processor may transmit data, store, and/or process data, such as for use later, or for use/interpretation by a user. For instance, the processor may synthesize TPMS data 880 from multiple collectors 200 over time, and provide useful information for utilization by user(s) via interface device(s) 700. The processor may store TPMS data 880 from multiple collectors 200 in collections repository database 550 for synthesization and/or other use at a later time.

A TPMS collection system 12 may comprise an address database 500. An address database 500 can facilitate associating a geographical location of a controller 200 with a vehicle associated with TPMS data 880 received by a controller 200. An address database 500 may comprise data including an unique identifier associated with each collector 200. The TPMS collection system 12 may identify which collector(s) 200 has/have received transmissions from the TPMS source 100. The TPMS collection system 12 may retrieve the location of the relevant collector(s) 200 from the address database 500. The TPMS collection system 12 can associate the geographic location of a collector 200 with a vehicle by querying the address database 500 to retrieve the unique identifier associated with each collector 200 and identify the location of the collector 200 having that unique identifier. The TPMS collection system 12 may determine the distance, direction, speed, and location of one or more TPMS source 100 by identifying the location of the collector(s) that receive TPMS data 880 associated with the one or more TPMS source 100. In other words, the TPMS collections system 12 may associate the geographic location of a reporting controller 200 with the vehicle identified as associated with the TPMS source 100 providing the TPMS data 880 received by the reporting controller 200. In further embodiments, each collector 200 may report its own location so that address database 500 may be said to be a distributed database and/or integrated with collector(s) 200.

A TPMS collection system 12 may comprise a collections repository database 550. A collections repository database 550 can store data received from other system elements, for example, TPMS data 880 received by one or more collector 200. The collections repository database 550 may be accessed by the controller 400, for example, in connection with processing other TPMS data 880 received in real time, or in connection with processing TPMS data 880 that has been stored in collections repository database 550, or in connection with any processing operation. Collections repository database 550 may also comprise processed data, for example, user queries, historical events, geographical locations of a collector 200 with a vehicle associated with TPMS data 880 received by a controller 200, which collector(s) 200 has/have received transmissions from the TPMS source 100. Because the TPMS collection system 12 can associate the geographic location of a collector 200 with a vehicle by querying the address database 500 to retrieve the unique identifier associated with each collector 200 and identify the location of the collector 200 having that unique identifier, this information, such as geographic associations, historical locations, etc. may be stored in the collections repository database 550. Moreover, previously determined distance, direction, speed, and location of one or more TPMS source 100 may be stored in the collections repository database 550. In other words, the collections repository database 550 may retain the associated geographic location of a reporting controller 200 that has been associated with a vehicle identified as associated with the TPMS source 100, and/or the identity of that vehicle and/or the TPMS data 880 received by the reporting controller 200. In further embodiments, each collector 200 may retain this data so that collections repository database 550 may be said to be a distributed database and/or integrated with collector(s) 200.

A TPMS collection system 12 may comprise one or more third-party data source 600. For example, a TPMS collection system 12 may comprise a first third-party data source 600-1, a second third-party data source 600-2, and any number ‘n’ of third-party data sources 600, such as a N^{th} third-party data source 600-n. In various embodiments, a TPMS collection system 12 comprises many third-party data sources 600. Alternatively, a TPMS collection system 12 may not comprise any third-party data sources 600, but may be configured to operatively communicate with (e.g., receive data from and/or send data to) but not comprise, one or more separate third-party data source 600.

A first third-party data source 600-1 may comprise one or more motor vehicle manufacturer data source, such as a database identifying the make and/or model and/or vehicle identification number and/or any other identifying information of a vehicle associated with a TPMS source 100. A second third-party data source 600-2 may comprise one or more law enforcement data source, such as a motor vehicle department database identifying the owner, owner address, license, insurance registration, liens, owner criminal record, or any other identifying information of an owner associated with the data of the first third-party data source (e.g., the owner of the vehicle assigned an identified vehicle identification number), or an entity, or surveillance data, or any other law enforcement information. Moreover, a third-party data source 600 may include commercial databases, such as Experian®, Equifax®, and TransUnion® databases; social media platforms, such as Twitter® or Facebook® or Yelp® or Foursquare®; or internet resources, such as Craigslist®; or any source of data. Furthermore, the first third-party data source 600-1 and/or the second third-party data source 600-2 may be editable by users via an interface device 700.

Finally, a TPMS collection system 12 may comprise one or more interface device 700. For example, a TPMS collection system 12 may comprise a first interface device 700-1, a second interface device 700-2, and any number ‘n’ of interface devices 700, such as a N^{th} interface device 700-n. In various embodiments, a TPMS collection system 12 comprises many interface devices 700. Alternatively, a TPMS collection system 12 may not comprise any interface devices 700, but may be configured to operatively communicate with, but not comprise, one or more interface device 700. An interface device 700 may comprise one or more web browser session, TELNET session, SSH session, wireless communication session, smartphone, app, mobile display terminal (“MDT”) communication session, electronic billboard, SMS messaging system, an annunciator or display on a vehicle panel, email, radio dispatching system, and/or any other mechanism by which a user may interact with the TPMS collection system 12.

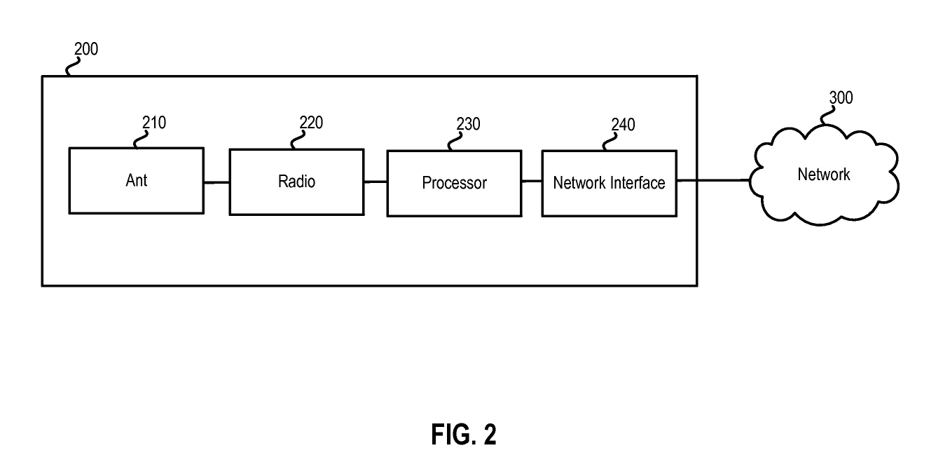

Having discussed various structural features of a TPMS collection system 12 and one or more TPMS source 100 within a TPMS monitoring environment 10, attention is directed to FIG. 2, wherein various aspects of a collector 200 are illustrated, and FIG. 4. A collector 200 may comprise an antenna 210, a radio 220, a processor 230, and a network interface 240. The collector 200 may receive radio transmissions comprising TPMS data 880 from TPMS source 100 at the antenna 210, and demodulate the radio transmissions at the radio 220 in order to isolate the TPMS data 880. In various embodiments, the radio 220 may pass the TPMS data 880 to the processor 230 for interpretation. For example, the processor may decode various values comprising the TPMS data 880 and may perform operations such as restructuring various parts of the TPMS data 880 for further transmission and/or processing, such as conveying this processed data to the network interface 240, which subsequently distributes the data to the network 300 for distribution to other components.

In various embodiments, the antenna 210 comprises a whip antenna. For instance, the antenna 210 may comprise a ¼ wave whip antenna. In further embodiments, the antenna may comprise a dipole antenna, a loop antenna, a log periodic antenna, a Yagi antenna, a printed circuit board trace antenna, or any antenna of any length, resonance, or having any supporting hardware, such as inductors, chokes, capacitors, resistors, filters such as discrete filters or distributed element filters, and/or feed lines, such as microstrip and/or stripline transmission lines, and/or connectors, such as an SMA connector, a BNC connector, a type-F connector, or type-N connector or any connector, whereby the radio transmissions comprising TPMS data 880 may be received from the TPMS source 100 and conducted to the radio 220. In various embodiments, the antenna 210 comprises an ANT-315-CW-RH antenna available from Linx Technologies, Inc. of Merlin, Oreg. In further embodiments, the antenna 210 comprises an ANT-433-CW-RH antenna, also available from Linx Technologies, Inc.

In various embodiments, the radio 220 comprises a software defined radio. For example, the radio 220 may comprise a Realtek RTL2832U. The radio 220 may be configured to capture radio transmissions from TPMS source 100 and extract the TPMS data 880 from the radio transmission(s). In further embodiments, the radio 220 only captures the TPMS data 880 and one or more other system element, such as network 300 and/or controller 400 extract the TPMS data 880. The radio 220 may be configured to capture radio transmissions provided on a center frequency/carrier frequency of about 315 MHz. Alternatively, or in addition, the radio 220 may be configured to capture radio transmissions from TPMS sources 100 provided on a center frequency/carrier frequency of about 433 MHz. One may appreciate that the radio 220 may be configured to capture radio transmissions from TPMS sources 100 provided on any desired frequency.

The radio 220 may comprise one or more demodulator configured to demodulate the radio transmission in order to extract the TPMS data 880 from the radio transmission. The radio 220 may comprise one or more demodulator configured to demodulate spread-spectrum radio transmissions, or radio transmissions that are amplitude modulated, frequency modulated, phase shift keyed, frequency shift keyed, mixed mode, or any other type of radio transmission. Thus, the radio 220 may comprise any radio receiver and/or transceiver configured to receive data transmitted wirelessly by one or more TPMS source 100 and potentially, transmit data wirelessly to one or more TPMS source 100, other controller 200, car transceiver 850, and/or any other component such as also by radio 220 and antenna 210, or by a different radio and/or antenna.

The processor 230 may comprise a Beaglebone Black embedded processor board. In further embodiments, the processor 230 may comprise any embedded processor board available from the Beagleboard Foundation of Richardson, Tex. Still further, the processor 230 may comprise a Raspberry Pi embedded processor board, such as a Raspberry Pi Model B embedded processor board available from the Raspberry Pi Foundation of Cambridge, UK. The processor 230 may comprise central processing unit having a tangible non-transitory memory. In further embodiments, the processor 230 may comprise an application specific integrated circuit (“ASIC”), and/or a field programmable gate array (“FPGA”). The processor 230 may perform operations on the data received by the radio 220 and may perform operations in response to the data. For instance, the processor 230 may comprise any device capable of providing processed data extracted from radio transmissions from TPMS sources 100 to the network interface 240 for distribution to the network 300.

The network interface 240 may comprise a wired network device, or may comprise a mobile broadband modem such as a cellular telephone data transceiver (for example, an AirCard® available from Netgear, Inc. of San Jose, Calif.), or may comprise a Wi-Fi interface device, or may comprise any logical connection between the processor 230 and the network 300 whereby the processor 230 and the network 300 may be in operative communication. The network interface may communicate by Bluetooth Low Energy (“BLE”) communication, by cellular communication, by Wi-Fi communication, by Near-Field Communication (“NFC”), or by any IEEE 802 standard communications technology, or by any technology, with the processor 230, and/or with the network 300. In further embodiments, the network interface 240 comprises an optical communication interface, for example, a fiber optic communication interface, or a through-the-air optical communication interface, such as by a laser or by infrared light.

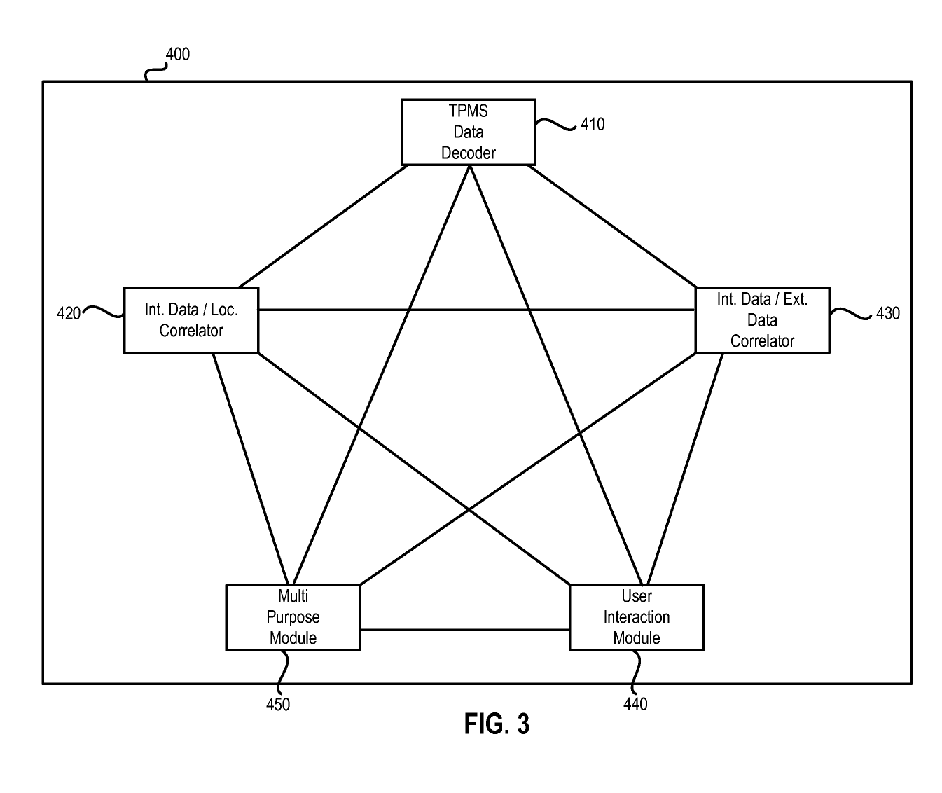

Having discussed various structural features of a TPMS collection system 12, and various aspects of a collector 200, attention is directed to FIG. 3, wherein a controller 400 is depicted in detail. A controller 400 may comprise various logical divisions. For example, a controller 400 may comprise a TPMS data decoder 410, an Internal Data/Location Correlator 420, an Internal Data/External Data Correlator 430, a User Interaction Module 440, and a Multi-Purpose Module 450. The controller 400 may execute various methods and perform various functions. For simplicity, the disclosure will discuss operations by controller 400, but one skilled in the art will appreciate that network 300, collector 200, or another component may perform one or more of the functions.

A TPMS data decoder 410 may receive TPMS data from one or more collector 200 via network 300. The TPMS data decoder 410 may extract relevant information from the TPMS data. For example, with additional reference to FIG. 4, TPMS data 880 may comprise one or more of a unique identifier 882, a temperature 884, a pressure 886, and other data 888. In various embodiments, the collector 200 has reformatted, or repackaged the TPMS data 880 to comprise different formats. In further embodiments, the TPMS data decoder 410 also receives data representative of the identity/location of the specific collector 200 that received the TPMS data 880. Thus, the TPMS data decoder 410 may receive data representative of at least a unique identifier of the TPMS source 100 (e.g., unique identifier 882) and a unique identifier of the collector 200 that received the TPMS data 880 from the TPMS source 100 (e.g., to determine the collector 200 location).

The TPMS data decoder 410 may be in logical communication with an Internal Data/Location Correlator 420. The Internal Data/Location Correlator 420 may access an address database 500, whereby the Internal Data/Location Correlator 420 may determine the location of the collector 200 that received the TPMS data 880 from the TPMS source 100. For example, the address database 500 may contain records linking the unique identifier of each collector 200 to the geographic location of each collector 200. The Internal Data/Location Correlator 420 may search the address database 500 for the collector 200 having the unique identifier received. Thus, the Internal Data/Location Correlator 420 may locate in the address database 500 a record corresponding to the collector 200 that received the TPMS data 880 from the TPMS source 100. The Internal Data/Location Correlator 420 may also edit/add in the address database 500 a record corresponding to the collector 200 that received the TPMS data 880 from the TPMS source 100, in response to instructions entered by a user via an interface device 700. In this manner, the Internal Data/Location Correlator 420 may be said to correlate the internal data reposed in the address database 500 and provided by the collector 200, with the real-world location of the collector 200. Moreover, the Internal Data/Location Correlator 420 may communicate with the collections repository database 550 so that the correlations identified may be stored/retrieved, calculations or processes performed by the Multi-Purpose Module 450 (discussed herein) may be stored/retrieved, and/or any other data may be stored/retrieved. For instance, historical locations of the collector 200 that received the TPMS data 880 from the TPMS source 100 may be store/retrieved. Furthermore, correlations of the internal data reposed in the address database 500 and provided by the collector 200 with the real-world location of the collector 200 may be stored/retrieved, automatically and/or in response to instructions entered by a user via an interface device 700. Furthermore, any information or correlations desired to be stored/retrieved may be stored in the collections repository database 550, as discussed herein. As such, the Internal Data/Location Correlator 420 may also communicate with the collections repository database 550 to access historical and/or previously stored data.

The TPMS data decoder 410 may be in logical communication with an Internal Data/External Data Correlator 430. The Internal Data/External Data Correlator 430 may access one or more third-party data source 600, whereby the Internal Data/External Data Correlator 430 may determine a correlation between the unique identifier of the TPMS source 100 that was received by the collector 200 from the TPMS source 100 and other identifying information, such as the make and/or model of the vehicle associated with the TPMS source 100, the vehicle identification number (“VIN”) of the vehicle associated with the TPMS source 100, and/or personally identifying information of the owner of the vehicle associated with the TPMS source 100 and/or law enforcement data. Thus, the Internal Data/External Data Correlator 430 may locate, in the third-party data source 600, a record corresponding to the unique identifier of the TPMS source 100 received. The Internal Data/External Data Correlator 430 may edit/add, in the third-party data source 600, a record corresponding to the unique identifier of the TPMS source 100 received, in response to instructions entered by a user via an interface device 700. In this manner, the Internal Data/External Data Correlator 430 may be said to correlate the external data reposed in one or more third-party data source 600 with the real-world identity of the vehicle and/or vehicle owner associated with the TPMS source 100. The Internal Data/External Data Correlator 430 may also communicate with the collections repository database 550 to store any of the various data and/or correlations related to its processes. The Internal Data/External Data Correlator 430 may communication with the collections repository database 550 to store and/or access historical and/or previously stored data.

The User Interaction Module 440 may be in logical communication with the Internal Data/Location Correlator 420, a Multi-Purpose Module 450, and the Internal Data/External Data Correlator 430. The User Interaction Module 440 may communicate with one or more interface device 700 via network 300 so that a user may access and/or interpret and/or add or edit the correlations identified, so that a user may access and/or interpret the functions of the Multi-Purpose Module 450, the Internal Data/Location Correlator 420, and the Internal Data/External Data Correlator 430, and so that a user may transmit queries and/or instructions to the controller 400, or otherwise interact with the controller 400 and its modules. Moreover, the User Interaction Module 440 may communicate with the collections repository database 550 so that the correlations identified may be stored, edited, or added, and calculations or processes performed by the Multi-Purpose Module 450 (discussed herein) may be stored, edited or added, and/or any other data desired to be stored, edited, or added may be stored, edited, or added in the collections repository database 550, as discussed herein.

The TPMS data decoder 410 may be in logical communication with a Multi-Purpose Module 450. A Multi-Purpose Module 450 may perform calculations or processes in response to the temperature 884, pressure 886, and/or other data 888. For example, the Multi-Purpose Module 450 may evaluate the temperature 884 and/or pressure 886 reported by one or more TPMS source 100, such as to determine the weather and/or road conditions of different roads, or to relate temperature 884 and/or pressure 886 and/or other data 888 to vehicle speeds, or vehicle locations, or to determine tire life and tire wear behavior. The Multi-Purpose Module 450 may evaluate any other data 888 comprising TPMS data 880.

The Multi-Purpose Module 450 may perform functions on the data, such as identifying the historical locations of a TPMS source 100 and providing targeted advertising or marketing information in response.

For instance, the Multi-Purpose Module 450 may access the collections repository database 550 to retrieve the historical locations of a TPMS source 100, or to add or edit such information. A vehicle associated with a TPMS source 100 may be identified by multiple collectors 200 at multiple points in time. By comparing the change in time and the change in location, the past, present, and predicted future location of the vehicle may be determined, the speed of the vehicle as it travels between different collectors 200 may be determined (by calculating distance divided by time), and the various determined data may be presented on a map, and/or stored in a collections repository database 550.

The Multi-Purpose Module 450 may access the Internal Data/External Data Correlator 430 to retrieve the identity of the person who owns the vehicle associated with the TPMS source 100, or to add or edit such information, and may access the collections repository database 550 to retrieve the historical locations of any other vehicles associated with other TPMS sources 100 that are owned by that person, or to add or edit such information. Moreover, the Multi-Purpose Module 450 may interact with third-party data sources 600 and craft a profile of the person that owns the relevant vehicle(s).

Thus, the Multi-Purpose Module 450 may cause a targeted advertisement to be launched on a video terminal adjacent to a gas pump in response to a vehicle pulling up to the gas pump. Vehicles that frequently visit a corporate office park may trigger advertisements for dry cleaning services, whereas vehicles that frequently visit construction sites may trigger advertisements for work boots. Vehicles owned by owners who also own many other vehicles may trigger advertisements for volume discounts whereas vehicles owned by owners who appear to be own only one vehicle may trigger advertisements for prepayment discounts. Moreover, the time-in-service and/or miles-in-services of vehicle tires may be determined by a Multi-Purpose Module 450. For example, a video terminal adjacent to a gas pump located at a gas station providing tire balancing and rotation services may display an advertisement for tire rotation and balancing services in response to a vehicle having one or more TPMS source 100 indicating a tire with sufficient time-in-service to need rotating. The Multi-Purpose Module 450 may store the data and/or the results of the functions performed on the data, and/or the functions themselves, in the collections repository database 550.

Still furthermore, the Multi-Purpose Module 450 may improve vehicle safety. For example, a tire pressure warning and directions to a self-service air compressor may be displayed on a highway billboard, in response to a vehicle with low tire pressure approaching a lengthy stretch of highway with no service facilities ahead. Moreover, the Multi-Purpose Module 450 may evaluate tire pressure 886, tire temperature 884, and/or other data 888. In response, an alert, such as a SMS, an email, an annunciation or display on a vehicle panel, or another alert, may be provided to a driver in the event that the driver's vehicle's tires are significantly hotter, or lower pressure, or higher pressure than those of nearby vehicles, or otherwise are behaving in a manner unexpected in view of the prevailing conditions. In this manner, marketing, behavioral analysis, vehicle efficiency analysis, data collection, traffic flow monitoring, vehicle safety functions, and/or other functions may be performed by a Multi-Purpose Module 450.

Moreover, a Multi-Purpose module 450 may enable the TPMS collection system 12 to communicate with third party systems, such as garage door openers, gate openers, driveway alarms, and the like. In this manner, gates and garage doors may be automatically opened in response to an authorized vehicle approaching. Furthermore, systems and methods herein may be combined with third-party systems to enable multi-factor authentication, such as to allow entry to a gate only when an authorized vehicle approaches in concert with a traditional garage door opener being activated. Furthermore, the Multi-Purpose module 450 may enable the TPMS collection system 12 to communicate with third party systems, such as toll collection systems, or commercial data providers, such as traffic reporting services.

Still furthermore, a multi-purpose module 450 may enable geofencing, so that a SMS, an email, an annunciation or display on a vehicle panel, or another alert, may be transmitted in the event that a vehicle leaves a predefined geographical area, such as to alert parents that a teenage driver has left school early, or has snuck out in the middle of the night, or is otherwise driving in a location, or a time that is designated by the user as prohibited.

Having discussed various aspects of a controller 400 in details, attention is directed to FIG. 4, which illustrates various aspects of a TPMS monitoring environment 10 and various communication relationships. A vehicle 800 may comprise a car transceiver 850 and a TPMS source 100. The TPMS source 100 may ordinarily communicate with the car transceiver 850 to provide information to the car transceiver 850 regarding the condition of one or more vehicle tire. The TPMS source 100 is typically located inside a vehicle tire. The TPMS source 100 may transmit TPMS source radio transmissions 802 to be received by the car transceiver 850. For example, with additional reference to FIG. 4, TPMS data 880 may comprise one or more of a unique identifier 882, a temperature 884, a pressure 886, and other data 888. Ordinarily, the car transceiver 850 may then take action in response to the TPMS source radio transmissions 802, such as causing an alert to be displayed on the vehicle dashboard in response to a TPMS source radio transmission 802 indicating that a pressure 886 is low. Similarly, the car transceiver 850 may transmit TPMS car transceiver radio transmissions 801 to the TPMS source 100. For example, when the vehicle is started, the car transceiver 850 may transmit TPMS car transceiver radio transmissions 801 to the TPMS source 100 instructing the TPMS source 100 to identify itself, to report tire condition or any other desired function.

A collector 200 may monitor these radio transmissions. For example, the collector 200 may receive the TPMS source radio transmissions 802 comprising TPMS data 880, and/or TPMS car transceiver radio transmissions 801. In this manner, the collector 200 may be said to monitor the TPMS data 880 and/or TPMS car transceiver radio transmissions 801.

A collector 200 may also send collector radio transmissions 803. In this manner, the collector 200 may be said to interrogate the TPMS source 100. For example, the collector 200 may send collector radio transmissions 803 emulating those expected from a car transceiver 850 (such as TPMS car transceiver radio transmissions 801). In this manner, the collector 200 may impel the TPMS source 100 to identify itself or to report tire condition or any other desired function. Moreover, the collector 200 may also send collector radio transmissions 803 emulating those expected by the car transceiver 850 from the TPMS source 100 (such as TPMS source radio transmissions 802). Thus, the collector 200 may report substitute data to the car transceiver 850, or may impel the car transceiver 850 to take any desired action, or to instruct the TPMS source 100 to take any desired action.

Thus, as one may appreciate, the collector 200 may passively monitor communication between the TPMS source 100 and the car transceiver 850 (“listening mode”). Similarly, the collector 200 may emulate one or more of the TPMS source 100 and the car transceiver 850 and impel the other to communicate or take any desired action (“emulation mode”). Moreover, the collector 200 may send different signals to the TPMS source 100 and the car transceiver 850 (“insertion mode”). Furthermore, the collector 200 may jam communications by one or both of the TPMS source 100 and the car transceiver 850 (“blocking mode”). A collector 200 may operate in any one of the above modes, or may operate in a combination of modes simultaneously, such as an insertion mode, combined with a blocking mode, or may operate in different modes at different times.

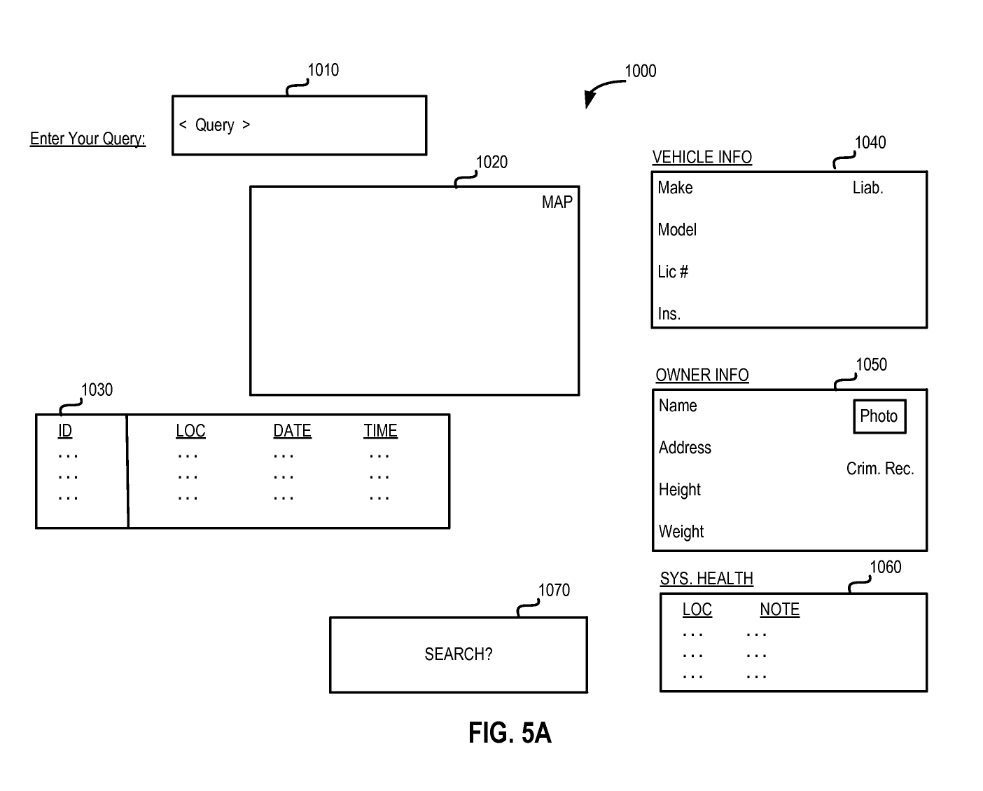

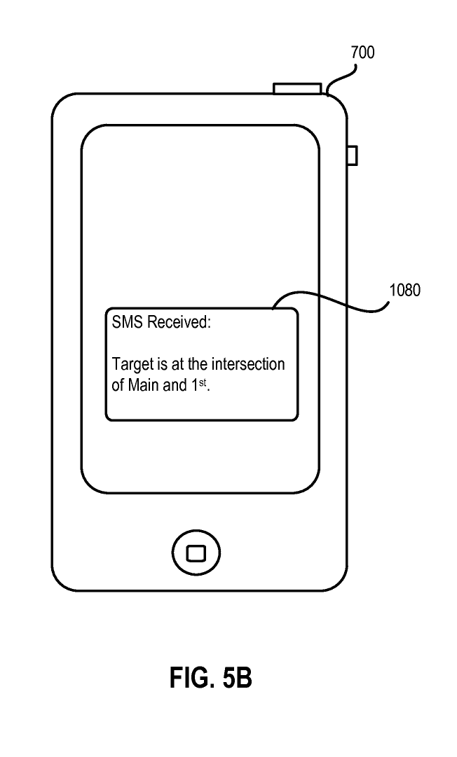

Having discussed various interactions between various features of a TPMS collection system 12 and between a TPMS collection system 12 and TPMS monitoring environment 10, attention is directed to FIG. 5A-B which illustrate various user interactions between a user and a TPMS collection system 12 operating in the TPMS monitoring environment 10. For example, an interface device 700 may comprise a web browser session causing a user interface 1000 to be displayed on a computer monitor. A user may enter a query 1010, which is received by the interface device 700. In response to the user activating a search button 1070, the query 1010 may be passed to the controller 400.

The controller 400 may take actions in response to the query 1010. The controller 400 may identify and display vehicle information 1040. The controller 400 may identify and display owner information 1050 of one or more vehicle. The controller 400 may display a map 1020 of one or more vehicle location.

This query 1010 may be associated with a TPMS source 100 that the user desires to inquire regarding. Moreover, this query 1010 may be associated with an owner the user wishes to inquire regarding. Still furthermore, this query 1010 may be associated with a vehicle the user wishes to inquire regarding, or it may be associated with any item of information capable of being processed by the controller 400. Thus, the controller 400 may take other actions in response to the query 1010, including retrieving, adding, or editing data such as historical records from the collections repository database 550.

The map 1020 may be a real-time map. The map 1020 may be a historical map. Furthermore, the map 1020 may indicate a subset of TPMS sources 100 that entered and/or exited a particular area over a particular period of time. The map 1020 may indicate any information associated with the tires associated with the TPMS sources 100, such as their locations, etc. The map 1020 may be displayed of multiple TPMS source 100 locations. Furthermore, the controller 400 may indicate the distribution of TPMS sources 100 in a geographical area shown in a map 1020, such as to depict traffic conditions on roadways.

Moreover, a user may be provided with information regarding the TPMS collection system 12 health 1060, such as any errors or malfunctions associated with different collectors 200 or other TPMS collection system 12 components. Furthermore, a user may be provided with raw data 1030, such as the date and time at which a TPMS source 100 was detected by one or more collector 200, whether as received in real-time, or stored in collections repository database 550.

In further embodiments, a user may desire to be alerted when a particular TPMS source 100 is detected, or moves, or enters a particular area, or any other desired event is detected. Thus, a user may set rules for the controller 400 to follow and to direct the controller 400 to provide an alert to the user via an interface device 700 when a desired event is detected. This rule may be stored in the controller 400, and/or in collections repository database 550. For instance, with reference to FIG. 5B, an interface device 700 may comprise a cellular telephone. A user may craft a rule wherein the controller 400 transmits a SMS message 1080 (or an email, an annunciation or display on a vehicle panel, or another alert) to the interface device 700 indicating that a specified event or action has occurred. In this manner, the user may be relieved from actively monitoring the interface device 700 to determine the occurrence of a specified event, and instead, the user may passively await the arrival of an alert, such as a SMS message 1080 (or an email, an annunciation or display on a vehicle panel, or another alert).

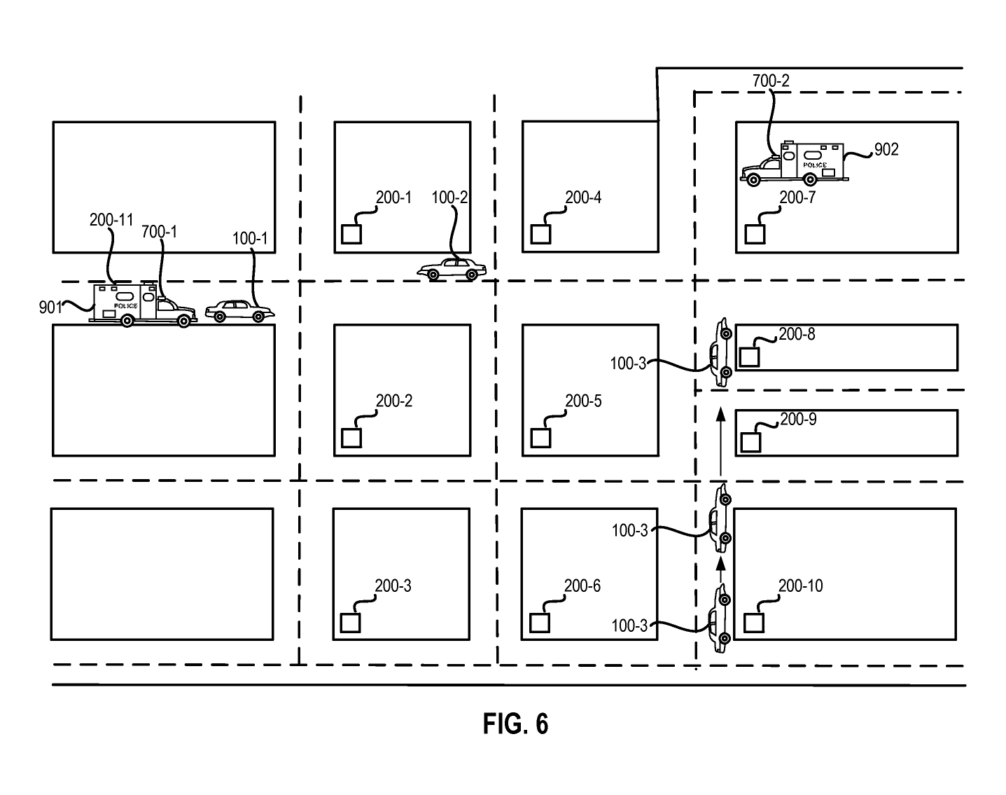

With reference to FIGS. 1-5B and particular reference to FIG. 6, a TPMS collection system 12 may provide desired information regarding a TPMS monitoring environment 10. For example, a first collector 200-1 through a tenth collector 200-10 may each be located at a different roadway intersection, so that TPMS sources 100 proximate to each roadway intersection may be detected. Moreover, an eleventh collector 200-11 may be located in a first law enforcement vehicle 901, and thus may be mobile so that TPMS sources 100 proximate to the first law enforcement vehicle 901 (such as first TPMS source 100-1) may be detected.

A first TPMS source 100-1 and a second TPMS source 100-2, and a third TPMS source 100-3 may be disposed in different vehicles operating in a TPMS monitoring environment 10. The first TPMS source 100-1 may be reposed in a vehicle traveling along a roadway. The second TPMS source 100-2 may be disposed within a vehicle at the intersection proximate to the fourth collector 200-4. The third TPMS source 100-3 may be disposed in another vehicle traveling along a roadway. An example TPMS collection system 12 operating in an example TPMS monitoring environment 10 will be discussed below with reference to these three TPMS sources 100-1, 100-2, and 100-3.

A user may receive a SMS message 1080 (or an email, an annunciation or display on a vehicle panel, or another alert) indicating that the second TPMS source 100-2 is proximate to the fourth collector 200-4. The second TPMS source 100-2 may be depicted as occupying a corresponding location on map 1020. Moreover, vehicle information 1040 and/or owner information 1050 may be provided at a user interface 1000 regarding second TPMS source 100-2, such as speed of travel.

A third TPMS source 100-3 may be disposed within a vehicle traveling along the roadway. For instance, the third TPMS source 100-3 may pass by the tenth collector 200-10, then the ninth collector 200-9, then the eighth collector 200-8. A user may desire to receive a prediction of where the vehicle containing the third TPMS source 100-3 will be located at a future time. The user may submit a corresponding query 1010 via the user interface 1000 of a second interface device 700-2 reposed within a second law enforcement vehicle 902. The controller 400 may provide a prediction in response. For example, the controller 400 may transmit a message to the second interface device 700-2 reposed in a second law enforcement vehicle 902. The message may direct the user to a location at which the user may intercept the TPMS source 100-3 based on a prediction of where the TPMS source 100-3 is likely to be traveling, for instance, a location proximate to a seventh collector 200-7.

A first TPMS source 100-1 may be reposed in a vehicle traveling along a roadway. A first law enforcement vehicle 901 may be following the vehicle. A first interface device 700-1 inside first law enforcement vehicle 901 may be used to submit a query 1010 requesting such information as the vehicle information 1040, and/or owner information 1050, and/or raw data 1030, such as historical location, and/or a map 1020 of prior vehicle locations of the vehicle containing first TPMS source 100-1. An eleventh collector 200-11 may also be located in the second law enforcement vehicle 902. In response to the query 1010, the controller (FIG. 1, 400) may evaluate a TPMS source radio transmission 802 from the first TPMS source 100-1 received by the eleventh collector 200-11. In further embodiments, in response to the query 1010, the controller (FIG. 1, 400) may direct the eleventh collector 200-11 to transmit a collector radio transmission (FIG. 4, 803) to impel the TPMS source 100-1 to identify itself and/or provide other data such as tire pressure, tire temperature, etc.

Also, the user may, via the interface device 700-1, instruct the controller 400 to set one or more rules regarding the first TPMS source 100-1. For example, the first TPMS source 100-1 may be added to a watch list, for example, to transmit a SMS message 1080 (or an email, an annunciation or display on a vehicle panel, or another alert) whenever the first TPMS source 100-1 travels near an area of interest, such as a known felon's residence, or an elementary school, or a forbidden area, or travels at an excessive speed. The controller 400 may store the rule (locally or in collections repository database 550), and run the rule, either in real-time, or on historical data, or on both real-time and historical data, and send an alert upon the occurrence of a condition satisfying the rule.

Moreover, rules may be set automatically, and without human intervention, based on the contents of third-party data sources 600. For example, a SMS message 1080 (or an email, an annunciation or display on a vehicle panel, or another alert) may be triggered anytime any vehicle owned by any registered sex offender identified in a third-party database 600 loiters near any elementary school identified in map 1020. Moreover, rules may be automatically set based on whether the vehicle is stolen. For example, all stolen vehicles in a jurisdiction may be flagged, and may be mapped, such as for recovery, or to identify areas with concentrated criminal activity such as chop shops and/or hiding places.

Now, having discussed various features of a TPMS collection system 12 operating in a TPMS monitoring environment, various methods of using a TPMS collection system 12 are disclosed.

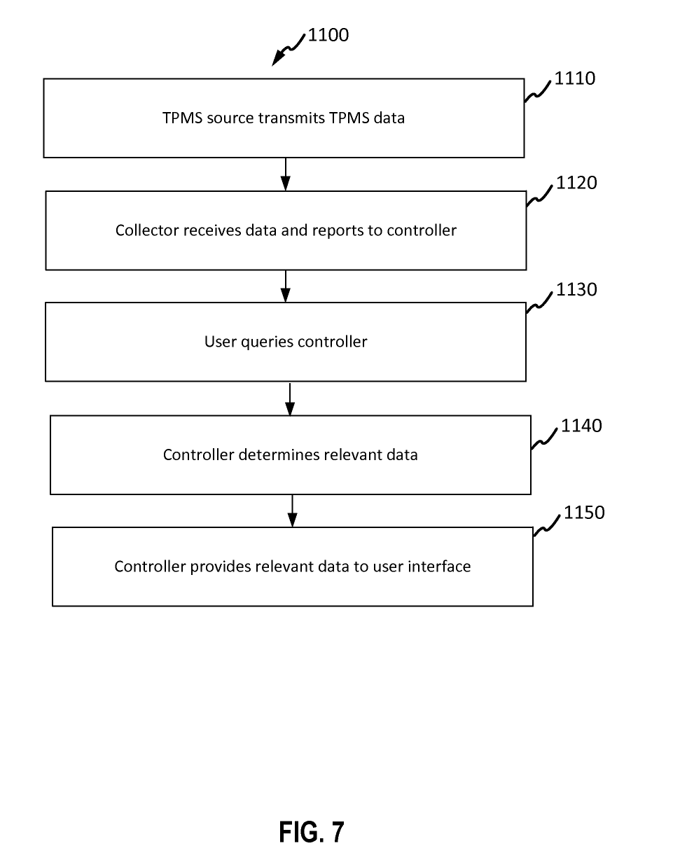

With reference to FIGS. 1-6, and particular reference to FIG. 7, a method 1100 of using a TPMS collection system 12 is disclosed. A TPMS source 100 may transmit TPMS data 880 (Step 1110). A collector 200 may receive the data and may convey at least a portion of the TPMS data 880 to a controller 400 (Step 1120). A user may input a query 1010 via a user interface 1000, directing a controller 400 to retrieve records corresponding to the TPMS source 100 (Step 1130). The controller 400 may comprise a TPMS data decoder 410, an Internal Data/Location Correlator 420, an Internal Data/External Data Correlator 430, a User Interaction Module 440, and a Multi-Purpose Module 450. The TPMS data decoder 410 may process the TPMS data 880 and determine that the TPMS data 880 originates from the TPMS source 100 that is relevant to the user's query 1010. In other embodiments, the TPMS data decoder 410 may look up data relevant to the user's query 1010 in various databases. For example, the TPMS source 100 may be associated with a vehicle having a VIN number comprising the user's query 1010. Subsequently, the Internal Data/Location Correlator 420 may determine the identity of the collector 200 that received the TPMS data 880 and correlate the identity of that collector to the location of that collector 200. The Internal Data/External Data Correlator 430 may determine at least one of the vehicle make, vehicle model, vehicle VIN number, and vehicle owner identity associated with the TPMS source 100 in response to the TPMS data 880. The Multi-Purpose Module 450 may determine the traffic density in the area immediately surrounding the TPMS source 100, such as to provide directions for law enforcement to quickly intercept the TPMS source 100 (Step 1140). Subsequently, the User Interaction Module 440 may process the various correlations and data into a user readable format and transmit it to interface device 700. In this manner, a user query may be responded to with information relevant to the user query (Step 1150).

In various embodiments, the various correlations and data are not automatically retrieved from third-party data sources 600-1, 600-2, but are manually determined by a user, such as a law enforcement officer, and manually entered into the third-party data sources, or into the collections repository database 550. In this manner, the system as described herein may also comprise an entirely self-contained data ecosystem wherein all data and correlations are obtained and determined internally. Thus it may be said that the third-party data sources 600-1, 600-2 comprise closed databases of internal data, rather than third-party data. In further embodiments, the system may omit the third-party data sources 600-1, 600-2 and the collections repository database 550 may accomplish the functions of the third-party data sources 600-1, 600-2 discussed herein, as well as other functions. In further embodiments, various features of various embodiments and configurations may be combined as desired. Still furthermore, different users may be provided different degrees of access to different aspects, functions, and/or data. For instance, a commercial user may be provided access to collections repository database 550, whereas a law enforcement user may be provided access to third-party data sources 600-1, 600-2. Alternatively, a first commercial user may be provided access to a first third-party data source 600-1, but not a second third-party data source 600-2, whereas a second commercial user may be provided access to a second third-party data source 600-2, but not a first third-party data source 600-1. As such, the any component discussed herein may further comprise access filtering. Such filtering may be accomplished by login credentials, security certificates, multi-factor authentication such as a combination of a certificate or password and also a SMS message with a one-time passcode which may be combined.

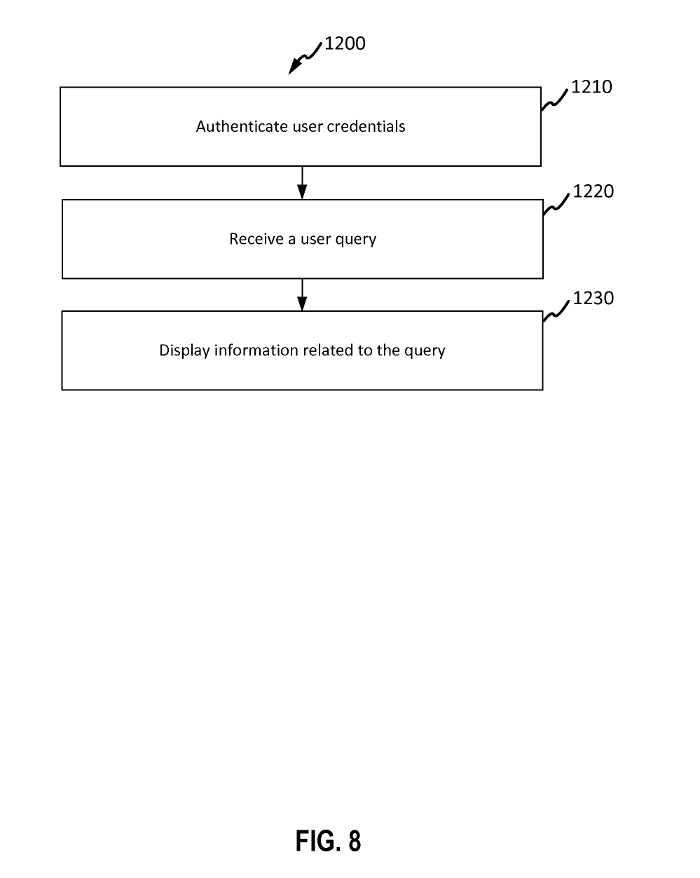

With reference to FIGS. 1-6 and particular reference to FIG. 8, a method 1200 of using a TPMS collection system 12 to retrieve stored data is disclosed. A user may authenticate user credentials, such as a user name and password by entering credentials via a user interface 1000, directing a controller 400, to permit access to records corresponding to the user's permissions (Step 1210). The user may input a query 1010 via a user interface 1000 (Step 1220), directing a controller 400 to retrieve records corresponding to the TPMS source 100, such as by entering a unique identifier 882. In further embodiments, the user may input a query 1010 via a user interface 1000 (Step 1220), directing a controller 400 to retrieve records corresponding to a VIN number associated with a TPMS source 100. In still further embodiments, the user may input a query 1010 via a user interface 100 (Step 1220) comprising rules and/or geofence settings in order to direct the controller 400 to transmit an alert, such as a SMS, an email, an annunciation or display on a vehicle panel, or another alert, in response to future detections of TPMS data 880 originating from the TPMS source 100 that is relevant to the user's query 1010.

The user interface 1000 may then display various information related to that TPMS source 100 (Step 1230). More specifically, the TPMS data decoder 410 may process the TPMS data 880 and determine that the TPMS data 880 originates from the TPMS source 100 that is relevant to the user's query 1010. In other embodiments, the TPMS data decoder 410 may look up data relevant to the user's query 1010 in various databases. For example, the TPMS source 100 may be associated with a vehicle having a VIN number comprising the user's query 1010. Subsequently, the Internal Data/Location Correlator 420 may determine the identity of the collector 200 that received the TPMS data 880 and correlate the identity of that collector to the location of that collector 200. The Internal Data/External Data Correlator 430 may determine at least one of the vehicle make, vehicle model, vehicle VIN number, and vehicle owner identity associated with the TPMS source 100 in response to the TPMS data 880 and/or user query. The Multi-Purpose Module 450 may determine the traffic density in the area immediately surrounding the TPMS source 100, such as to provide directions for law enforcement to quickly intercept the TPMS source 100 or to provide mapping information. Thus, the Internal Data/Location Correlator 420 may determine the date, time, and locations of the TPMS source 100 that is relevant to the user's query 1010, whether the query comprised a VIN number, or an unique identifier detected by any collector 200.

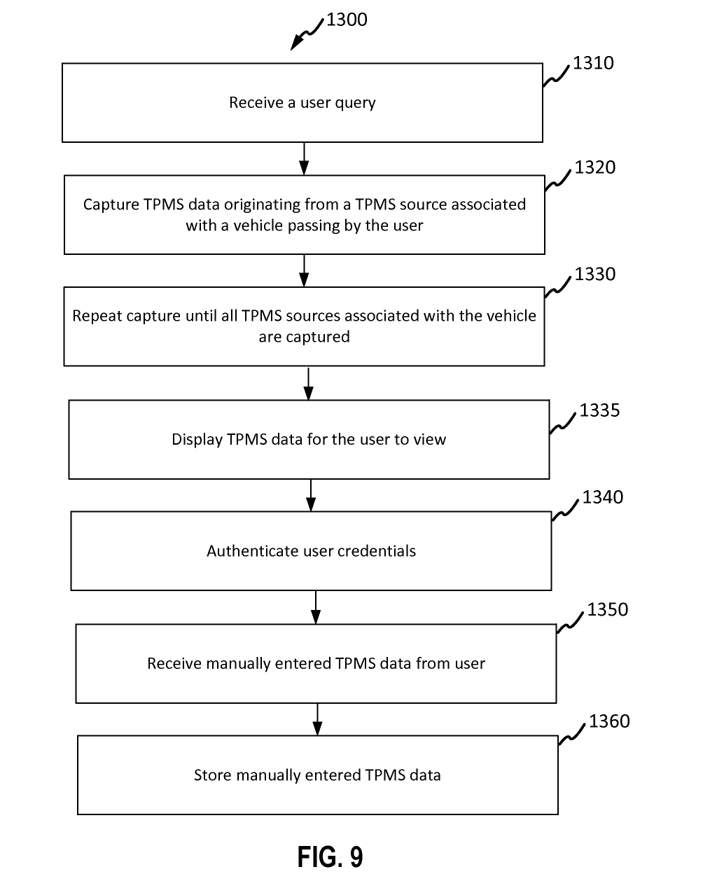

With reference to FIGS. 1-6 and particular reference to FIG. 9, a method 1300 of using a TPMS collection system 12 to identify a passing vehicle is disclosed. A user may input a query 1010 via a user interface 1000 (Step 1310), directing a controller 400 to direct a specific collector 200 located, for example, in that user's law enforcement vehicle, to capture TPMS data 880 originating from a TPMS source 100 that is relevant to the user's query 1010, such as a request to capture the TPMS data 880 origination from a TPMS source 100 that is passing by or near to the user (and thus the specific collector 200) (Step 1320). The user may optionally repeat this process to collect different TPMS data 880, for example, in the event that multiple TPMS sources 100 are associated with a single vehicle (such as one for each tire) (Step 1330). The TPMS data that is captured may be displayed for the user to view (Step 1335). The user may authenticate user credentials, such as a user name and password by entering credentials via a user interface 1000. The user may direct a controller 400, to permit access to records corresponding to the user's permissions (Step 1340). The user may then enter the captured TPMS data 880 (Step 1350), such as to tag a particular vehicle with the TPMS data 880. The controller 400 may store this data (Step 1360) so that in response to future queries, the Internal Data/External Data Correlator 430 and/or other system components may determine at least one of the vehicle make, vehicle model, vehicle VIN number, and vehicle owner identity associated with the TPMS source 100 in response to the TPMS data 880 and/or user query.

Furthermore, and with reference to FIGS. 1-9, as discussed, each unique identifier 882 is associated with a TPMS source 100. Also as discussed, each vehicle may be associated with multiple TPMS sources 100. As such, each vehicle may be associated with multiple unique identifiers 882. Consequently, the system may be configured to associate multiple unique identifiers 882 and/or TPMS sources 100 with each vehicle. As such, the receiving of multiple unique identifiers 882 from a single vehicle may serve to increase the confidence of the identification of the vehicle.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general-purpose digital computers or similar devices.

In various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows operating system, UNIX®, Linux®, Solaris®, MacOS, etc.) as well as various conventional support software and drivers typically associated with computers.

Computer system also includes a main memory, such as for example random access memory (“RAM”), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (“EPROM”), or programmable read only memory (“PROM”)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (“PCMCIA”) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (“RF”) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (“ASICs”). Implementation of the hardware state machine so as to perform the functions described herein will be apparent to persons skilled in the relevant art(s).

A web client and/or interface device includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as iPads, iMACs, and MacBooks, kiosks, terminals, point of sale (“POS”) devices and/or terminals, televisions, or any other device capable of receiving data over a network. A web-client may run Microsoft Internet Explorer®, Mozilla Firefox®, Google® Chrome, Apple® Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

In various embodiments, components, modules, and/or engines of systems may be implemented as micro-applications or micro-apps (“apps”). Micro-apps are typically deployed in the context of a mobile operating system, including for example, a Palm® mobile operating system, a Windows® mobile operating system, an Android® Operating System, Apple® iOS, a Blackberry® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any cloud, cloud computing system or communications (e.g., electronic) system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (“LAN”), wide area network (“WAN”), virtual private network (“VPN”), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein.

The various system components may be independently, separately or collectively suitably coupled to the network via data links which includes, for example, a connection to an Internet Service Provider (“ISP”) over the local loop as is typically used in connection with standard modem communication, cable modem, Dish Networks®, ISDN, Digital Subscriber Line (“DSL”), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (“ITV”) network. Moreover, the system contemplates the use, sale or distribution of any items, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP 800-145.pdf (last visited May 2014), which is hereby incorporated by reference in its entirety. While various aspects of the disclosure herein, such as network 300 (FIG. 1) may incorporate cloud computing, in further embodiments, various aspects may not incorporate cloud computing, depending on desired characteristics, data integrity, security concerns, etc.

As used herein, “transmit” may include sending electronic data from one system component to another over a network connection. Additionally, as used herein, “data” may include encompassing information such as commands, queries, files, data for storage, and the like in digital or any other form.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, GPG (“GnuPG”), and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the Microsoft Internet Information Server (“IIS”), Microsoft Transaction Server (“MTS”), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (“ADO”) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (“ASP”), common gateway interface scripts (“CGI”), extensible markup language (“XML”), dynamic HTML, cascading style sheets (“CSS”), AJAX (“Asynchronous Javascript And XML”), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQ™ (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

Functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. §101.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A tire pressure monitoring system (“TPMS”) collection system comprising:
a collector whereby TPMS data is received;
a controller whereby an identity of a source of the TPMS data is determined; and
a user interface whereby the identity of the source is displayed to a user.

2. The TPMS collection system according to claim 1, wherein the user interface comprises a map displayable in response to a query associated with the source of the TPMS data.

3. The TPMS collection system according to claim 2,
wherein the map comprises one of a real-time map and a historical map, and
wherein the map indicates a subset of TPMS sources that have at least one of entered and exited an area during a time period.

4. The TPMS collection system according to claim 1,
wherein the controller is configured to receive a rule from the user, wherein the controller stores the rule in a collections repository database, and
whereby the rule directs the controller to transmit to the user interface a SMS message indicating that a specified event has occurred.

5. A collector comprising:
a radio in RF communication with a remote, mobile TPMS source, wherein TPMS data is received by the radio from the remote, mobile TPMS source; and
a network interface in logical communication with the radio, wherein the network interface provides at least a portion of the TPMS data to a network.

6. The collector according to claim 5, further comprising a processor whereby an unique identifier of the remote, mobile TPMS source is obtained from the TPMS data, wherein the remote, mobile TPMS source is identified.

7. The collector according to claim 6, the processor further comprising:
a TPMS data decoder configured to extract the at least a portion of the TPMS data;
an internal data/location correlator configured to access an address database containing records linking an unique identifier of the collector to a geographical location of the collector whereby the internal data/location correlator determines a location of the collector;
an internal data/external data correlator configured to access a third party data source to determine a correlation between the at least a portion of the TPMS data and the external data; and
an user interaction module configured to accept queries from a user.

8. The collector according to claim 7, wherein the external data comprises an identifying information comprising at least one of: a vehicle make, a vehicle model, a vehicle identification number, and a personally identifying information of an owner of the vehicle.

9. The collector according to claim 7, wherein the internal data/location correlator is further configured to communicate with a collections repository database whereby historical data may be retrieved.

10. The collector according to claim 7, wherein the at least a portion of the TPMS data comprises the unique identifier of the remote, mobile TPMS source.

11. The collector according to claim 10, wherein the at least a portion of the TPMS data further comprises a temperature, and a pressure.

12. The collector according to claim 7, wherein the processor further comprises a multi-purpose module configured to access a collections repository database to retrieve the TPMS data collected by a remote collector remote from the collector.

13. The collector according to claim 7, wherein the processor further comprises a multi-purpose module configured to access the internal data/external data correlator to retrieve an identity of a person who owns a vehicle associated with the TPMS data.

14. The collector according to claim 7, wherein the processor further comprises a multi-purpose module configured to access the internal data/external data correlator to retrieve a targeted advertisement in response to the external data.

15. A method of using a TPMS collection system comprising:
receiving, by a collector, TPMS data;
conveying, by the collector, at least a portion of the TPMS data to a controller in logical communication with the collector;
retrieving records corresponding to a remote, mobile TPMS source by the controller in response to a query received from a user by a user interface in logical communication with the controller,
wherein the controller comprises a TPMS data decoder, an internal data/location correlator, an internal data/external data correlator, a user interaction module, and a multi-purpose module;
processing by the TPMS data decoder, the TPMS data and determining that the TPMS data originates from the remote, mobile TPMS source relevant to the query;
determining by the internal data/location correlator an identity of the collector; and
correlating by the internal data/location correlator the identity of the collector to a location of the collector.

16. The method according to claim 15, further comprising determining by the internal data/external data correlator at least one of a vehicle make, vehicle model, vehicle VIN number, and vehicle owner identity associated with the remote, mobile TPMS source in response to the TPMS data.

17. The method according to claim 15, wherein the processing comprises determining that the remote, mobile TPMS source is associated with a vehicle having a VIN number comprising a user's query.

18. The method according to claim 15, further comprising providing by the multi-purpose module a traffic density in an area surrounding the remote, mobile TPMS source.

19. The method according to claim 15, further comprising providing directions to law enforcement to intercept the remote, mobile TPMS source.

20. The method according to claim 15, further comprising:
providing by the user interaction module, a response to a user query in response to the determining; and
transmitting, by the user interaction module, the response to an interface device.
